(19) United States
(12) Patent Application Publication
(10) Pub. No.: US 2008/0177504 A1
(43) Pub. Date: Jul. 24, 2008

(54) METHOD, SYSTEM, SIGNAL AND PROGRAM PRODUCT FOR MEASURING EDUCATIONAL EFFICIENCY AND EFFECTIVENESS

(75) Inventor: Glenn A. Niblock, Pensacola, FL (US)

Correspondence Address: LARSON AND LARSON, 11199 69TH STREET NORTH, LARGO, FL, 33773, US

(73) Assignee: NIBLOCK & ASSOCIATES, LLC, Pensacola, FL (US)

(21) Appl. No.: 11/625,668

(22) Filed: Jan. 22, 2007

(51) Int. Cl. G09B 7/00; G06F 17/30

(52) U.S. Cl. 702/182

(57) ABSTRACT

An application for a method for measuring educational efficiency and effectiveness of a teacher and a group of students includes measuring amounts of effort and/or expense expended during teaching activities and accumulating the amounts of effort and/or expense into an accumulated effort and/or expense. The knowledge level of the group of students is measured before the educational activities and measured after the educational activities. The educational efficiency and effectiveness of the teacher is calculated based upon the difference between the knowledge level of the group of students before the teaching activities and the knowledge level of the group of students after the teaching activities divided by the accumulated effort and/or expense.

### BACKGROUND OF THE INVENTION

1. Field of the Invention

This invention relates to the field of teaching and more particularly to a system and method for measuring the efficiency and the effectiveness of the educational process and systems.

2. Description of the Related Art

Teaching is a skill and an art. Being such, it is often difficult to measure the quality of education that has occurred. Teachers, professors, instructors and the like have varying attributes such as education, subject matter knowledge, personalities, styles, emotions, drive, speech patterns, etc. In addition, teachers contend with classes of varying size that affect their ability to interact with students in the classroom, and in any help sessions. Likewise, their students also have varying attributes such as prior education, personalities, styles, emotions, drive, attention patterns, study skills, etc. It is often hard to measure, let alone predict the outcome of a learning experience involving a subject, a teacher, a set of students and a time frame because of the complex interactions among this myriad of attributes.

Often, teachers are rated, and perhaps paid, based upon years in teaching. Although there may be some correlation between years in teaching, teaching ability and teaching effectiveness, there is no absolute direct relationship and, therefore, this evaluation method falls short.

In recent times, standardized tests have been used to measure the level a group of students have achieved on specific subjects or a broad range of knowledge. Many of these tests have been deployed to help colleges and institutions evaluate new student prospects, for example, the SAT and GRE exams. Most, if not all states, such as California, Florida, Ohio and New York, have standardized tests for evaluating the overall achievement of a group of students such as an entire grade level within a particular school. Such tests are used to evaluate the school and the overall school's ability to teach. Although still in use at the time of filing, this system has inaccuracies due to student demographics, teacher attributes, public pressure, etc., but especially because of several features of the present invention that are missing from such evaluations.

The prior art has several examples of methods for measuring teaching success. For example, U.S. patent Publication 20050297505 to George describes a method of teaching success. This method may help students generate and achieve goals, but it does not measure the efficiency or effectiveness of the teacher or of the educational system.

U.S. patent Publication 20040157201 to Hollingsworth, et al., describes a method for evaluating educational effectiveness. This method uses “time on task” and “instructional effectiveness” to evaluate educational effectiveness, but does not measure overall efficiency and effectiveness of the educator, nor the process employed by the educational system.

U.S. Pat. No. 6,789,047 to Woodson describes a method for evaluating an instructor using data captured during an electronic course (online) such as attendance and response time to questions. It does not measure before and after results and time spent.

What is needed is a system and method that will measure the efficiency and effectiveness of the educational system at several levels so that potential improvements can be identified and implemented.

### SUMMARY OF THE INVENTION

In one embodiment, a system for measuring efficiency of educational activities is disclosed including a computer with software running on the computer for accepting inputs indicating an amount of effort expended and accumulating these inputs into an accumulated effort. Software is provided for accepting inputs indicating an educational goal such as credit-hours gained, a knowledge level of a group of students before the teaching activities are performed, and for accepting inputs indicating a knowledge level of the group of students after the teaching activities are performed, measuring the incremental progress toward the new educational plateau. Software is also provided for calculating the educational efficiency based upon the difference between the knowledge level of the group of students before the educational activities and the knowledge level of the group of students after the educational activities divided by the accumulated effort which may include non-classroom work such as homework preparation, study time, and time researching issues.

In another embodiment, a method for measuring educational efficiency and effectiveness of an educator and a group of students toward an educational goal is disclosed including measuring both the amounts of effort expended during educational activities and accumulating the direct costs of teaching (teacher wages and classroom and laboratory supply costs into an accumulated cost. The knowledge level of the group of students is measured before the teaching activities and measured after the teaching activities. The educational efficiency and effectiveness are calculated based upon the difference between the knowledge level of the group of students before the teaching activities and the knowledge level of the group of students after the teaching activities divided by the accumulated effort and direct teaching cost, including teacher wages and the costs of classroom and laboratory supplies.

In another embodiment, a computer readable medium tangibly embodying a program of instructions, the program of instructions configured to for measuring teaching efficiency and effectiveness of an educational system employed for teaching a varying sized group of students is disclosed including computer instructions for measuring amounts of effort and cost expended during teaching activities and computer instructions for accumulating the amounts of effort and cost expended during teaching activities into an accumulated effort and the accumulated expenses associated with providing the classroom opportunity such as teacher wages, classroom and laboratory supplies, and administrative, teacher wages, classroom and laboratory supplies, operations and maintenance expenses, as well as related costs such as transportation. Computer instructions are provided for measuring the knowledge level of the group of students before the teaching activities and for measuring the knowledge level of the group of students after the teaching activities. Furthermore, computer instructions are provided for calculating the teaching efficiency and effectiveness based upon the difference between the knowledge level of the group of students before the teaching activities and the knowledge level of the group of students after the teaching activities divided by first the accumulated effort, and then by the expenses associated with providing the educational opportunity described previously.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a typical computer system of all embodiments of the present invention.

FIG. 2 illustrates a first flow chart of all embodiments of the present invention.

FIG. 2A illustrates a flow chart of a first classroom example using the present invention.

FIG. 2B illustrates a flow chart of a second classroom example using the present invention.

FIG. 3 illustrates a second flow chart of the first embodiment of the present invention.

FIG. 4 illustrates a third flow chart of the second embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

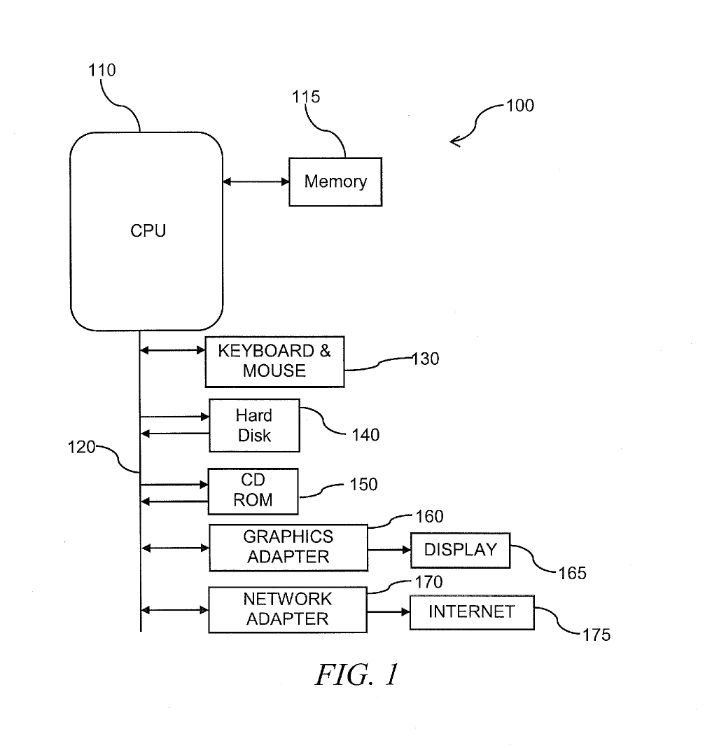

Referring to FIG. 1, a typical computer 100 configuration of the present invention is shown. This exemplary configuration is well known in the prior art. Although shown in a much simplified configuration having a single processor, many different computer architectures are known that accomplish similar results in a similar fashion and the present invention is not limited in any way to any particular computer system. The present invention works well utilizing a single processor system as shown; a multiple processor system where multiple processors share resources such as memory and storage; or a multiple server system where several independent servers operate in parallel or any combination. In this, a processor 110 is provided to execute stored programs that are generally stored for execution within a memory 115. The processor 110 can be any processor or a group of processors, for example an Intel Pentium-4® CPU or the like. The memory 115 is connected to the processor and can be any memory suitable for connection with the selected processor 110, such as SRAM, DRAM, SDRAM, RDRAM, DDR, DDR-2, etc. Also connected to the processor 110 is a system bus 120 for connecting peripheral subsystems such as a keyboard/mouse 130, a hard disk 140, a CDROM 150, graphics adapter 160 and network adapter 170. The graphics adapter 160 receives commands and display information from the system bus 120 and generates a display image that is displayed on the display 165. The network adapter 170 receives commands and data from the system bus 120 and communicates with the World Wide Web or Internet 175, through a modem or other communication device (not shown).

In general, the hard disk 140 may be used to store programs, executable code and data persistently, while the CDROM 150 may be used to load said programs, executable code and data from removable media onto the hard disk 140. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. In some embodiments, other devices are connected to the system through the system bus 120 or with other input-output connections. Examples of these devices include printers; mice; graphics tablets; joysticks; and communications adapters such as modems and Ethernet adapters.

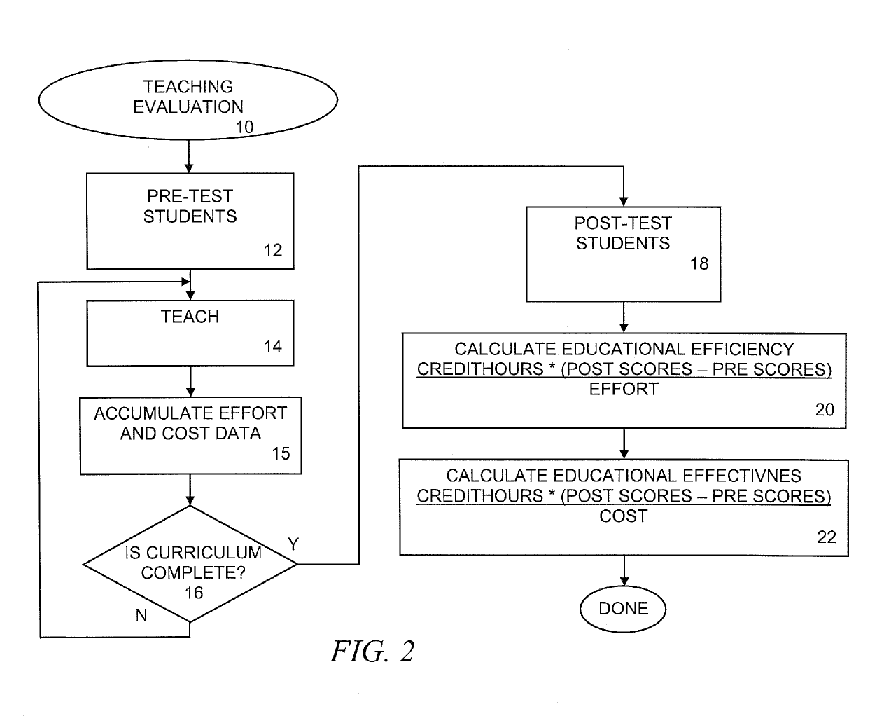

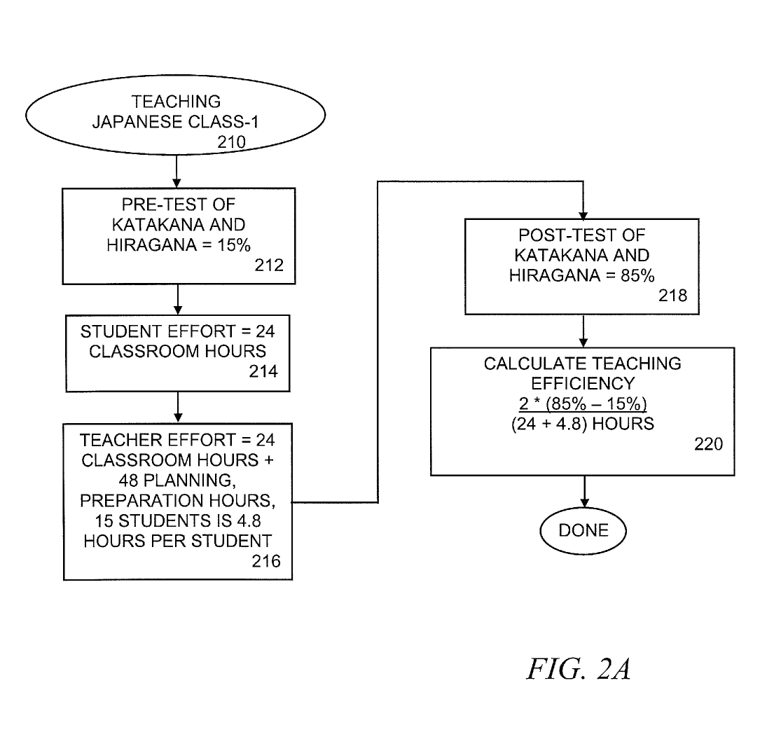

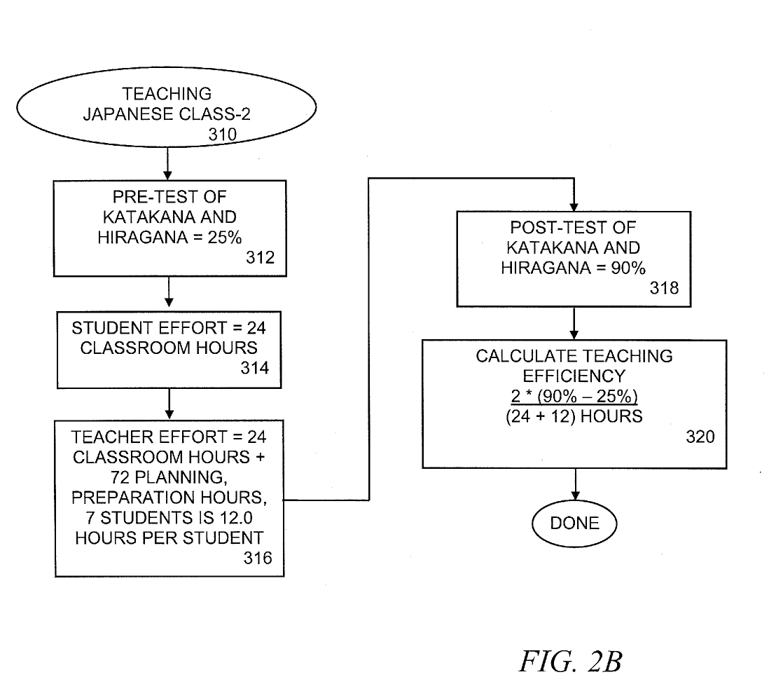

Referring to FIG. 2, a first flow chart of all embodiments of the present invention will be described. Teaching evaluation 10 begins with a pre-test of the students taking a particular class or entering a new grade level 12. This provides a baseline measurement of the knowledge and understanding of the subject matter that is about to be presented and taught. The test is particular to the student's knowledge of the educational goal, successful completion of a course measured, for example, in credit-hours, as opposed to overall evaluation of the student's general knowledge. In some embodiment, the pre-test is actually the final test from the year prior. For example, in a grade school environment, the students in grade 4 might have a final exam in math, and this final exam would serve as the pre-test for grade 5.

Next, teaching proceeds 14 and during such, the amount of effort and cost is accumulated 15. The amount of effort is a measure of work expended by the students and educator and includes some or all of classroom time, study time, homework time, discussion group time, educator time spent grading, preparation, research, tutoring, etc. Costs are those expenses associated with providing the educational opportunity being evaluated, and for some measures may be partial costs. If the curriculum is not complete 16, the steps of teaching 14 and accumulating effort and costs 15 are repeated until the curriculum is complete 16. Once complete, the students are again tested using a post-test 18. The post-test is, necessarily, similar in scope but preferably not identical to the pre-test and therefore provides a measurement of how much the students learned during the teaching steps. Subtraction of the pre-test results from the post-test results provides a measurement of basic learning. It represents the fraction of the educational goal; for example the course credit hours mastered in the course measured. This measurement of basic learning is just that—how much more the students know now than they knew before the course began. This raw measurement does not take into account either the amount of time expended or the monies expended to achieve this increment of learning. The basic learning (post-test scores minus pre-test scores) is divided by the accumulated effort 20 to provide a measurement of educational efficiency. Likewise, the basic learning (post-test scores minus pre-test scores) is divided by the accumulated cost 22 to provide a measurement of educational effectiveness.

For example, consider two United States Department of Commerce classes, one of 15 students and another of 8 students, learning the Japanese language. The subject matter is taken in this example as two (2) college-level credit-hours. In Japanese 101, one must first learn the Katakana and Hiragana characters used as a phonetic alphabet. Both classes are tested before any teaching occurs to see how many of the Katakana and Hiragana characters are recognized by the students. Referring to FIG. 2A, the first class 210 scores an aggregate average of 15% on the pre-test (e.g., the students successfully identified 15% of the Katakana and Hiragana characters), perhaps due to the random chance of getting a right answer on a multiple choice question or prior independent study. During the teaching/learning process, 28.8 hours are spent in the educational process. This time is comprised of 24 student hours in class 214 and the time spent by the teacher in class, and in planning, preparation, and grading interim tests and homework allocated evenly to each student. The latter amounts to 24 teacher class hours +48 hours grading, planning and reviewing giving a total of 72 hours, or 4.8 hours per student in a class of 15 students, for a total educational effort of 28.8 hours per student 216. In this example student effort outside the classroom for homework and other studies was assumed not to have been reported. Post-test results gave an average score of 85% 218. If methods of the prior art were applied to these scores, it would have looked like the students started with very little knowledge and finished with a good knowledge, but nothing would account for how well the educator performed or how much effort the educator and students expended to achieve their accomplishment. To provide these measures, the measured gain in class knowledge (85%-15%) is multiplied by the learning goal of two (2) credit hours per student and divided by the overall effort of 28.8 hours per student to determine teaching efficiency 220. In this example, the average educational efficiency is 2×(0.85−0.15)/28.8, or approximately 0.049. The effectiveness is given by the educational accomplishment (percentage of the course content of 2 credit hours divided by the educational effort and by the cost of providing the educational opportunity.

Assuming a teacher salary allocated to this course of $400 per student per credit hour and no other costs, the cost effectiveness is determined by dividing the efficiency by the cost to arrive at a value of 0.1215 credit-hours/hr/$1000.

Referring to FIG. 2B, the second class 310 scores 25% on the pre-test 312, perhaps due to the random chance of getting a right answer by most of the students but also because a few students already knew many of the Katakana and Hiragana characters. During the learning period, the same 24 student-hours are spent in class 314. Assuming the second teacher isn't as skilled as the first teacher, the second teacher takes 50% more time for planning, preparation, and grading, giving a total of 12.0 instructor hours per student, for a total educational effort of 36 hours per student 316. Post-test results give an average score of 90% 318.

If methods of the prior art were applied to these scores, it would have looked like the second set of students started with slightly more knowledge and finished with slightly more knowledge than the first group, but nothing would indicate which teacher performed better at teaching and motivating each class. Moreover, much of any difference would be masked by the difference in class size. For the second class, as per the present invention, the measured gain in knowledge (90%-25%) is multiplied by the learning goal of two (2) credit hours and is divided by the work effort of 36 hours to determine the teaching efficiency 320. In this example, teaching efficiency is 2×(0.90−0.25)/36, or 0.036. The effectiveness is calculated as in the first instance. Because of the smaller class size, even though the teacher wage rate is constant, the per student cost increases to $750 per student per credit hour. The effectiveness for the second class thus is 2×(0.90−0.25)/36/750 giving an effectiveness of 0.0481 credit-hours/hour/$1000.

Both classes finished knowing roughly the same measured number of Hiragana and Katakana characters and both are adequately prepared to move on to the next level of Japanese learning. By simply comparing the post-test results of the first educator (85%) to the second educator (90%), it would appear that the second class (or perhaps teacher) out performs the first, a result the present invention shows to be incorrect. The present invention provides a superior method for purpose of comparing educators, educational environments, curriculum, teaching methods, etc. Using the teaching efficiency and effectiveness measures make it clearer that the first class's educational experience was superior despite a lower post-test score.

The efficiency and effectiveness results might lead one to conclude that the teacher for the second class was substantially inferior. An advantage of the present invention is that an externality such as class size can be isolated analytically. When the results are adjusted for class size the efficiency and effectiveness are 0.043 and 0.107 per credit hour/hr/$1000, indicating that the teacher for class 2 is somewhat less capable but not nearly as much as might be inferred from the unexamined initial data. There are also potential effects of additional effort required by the second class if the teacher is less effective and students spend more hours for studying and preparing homework. These students may have less time to devote to other class work, extra curricular activities, etc. They may perform less than optimal in sports, other classes, social experiences, etc.

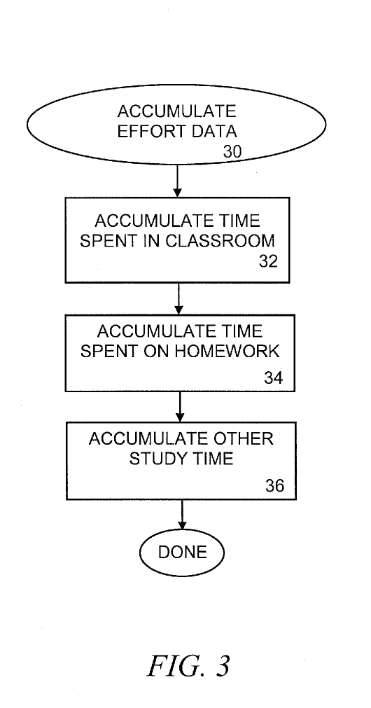

Referring to FIG. 3, a flow chart of accumulating effort data according to the first embodiment of the present invention will be described. Effort data, in this example, includes classroom time and time spent on homework and other study activities. Therefore, the accumulation of effort data 30 includes summing the time spent in classroom 32; the time spent on homework 34; and the time spent on other studying 36. Assuming the teacher of the second class is less effective this may cause extra work for the students. For example, assume that students report that in addition to time in the classroom, they spend 12 more hours on homework, and 24 more hours studying than the students in the first class. This additional time required of the students in the second class reduces the efficiency to 0.018 and the effectiveness to 0.0241. In this example the present invention reveals that the greater study time required of the students does reduce both the efficiency and effectiveness of the educational process.

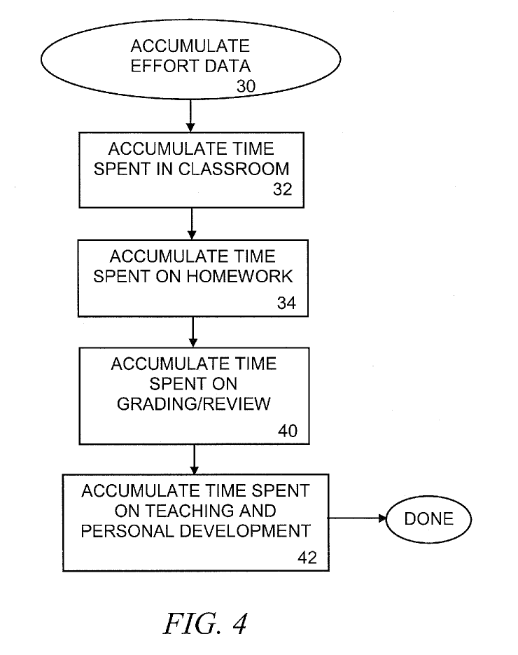

Referring to FIG. 4, a flow chart of accumulating effort data according to the first embodiment of the present invention will be described. Effort data, in this example, includes classroom time, the additional time spent by students, time spent on homework and educator time spent in ancillary activities related to teaching. The total time spent by the educator includes not only time spent planning, preparing, grading tests, time spent grading homework and time spent reviewing/modifying the curriculum, but also an allocation of time spent in training, and other related professional development activities. Therefore, in this example, the accumulation of effort data 30 includes summing the time spent in classroom 32, the time spent on homework 34 and the time spent on grading/review 40 and the time spent on teacher and professional development 42.

The expenses attributable to the educational experience that are measurable in dollars include the cost of educator salaries, resource costs, equipment costs, facility costs, travel expense, training or seminar fees, and other education related expense.

The following are examples of expense measurements at an individual class level:
Classroom Teaching Expense: educator and aide's direct wages and benefits (salaries).
Classroom Supply Expense: books, flip charts, paper, etc.
Laboratory Teaching Expense: Laboratory teacher and aide's direct wages and benefits (salaries).
Laboratory Supply Expense: Laboratory supplies biological samples, chemicals, etc.
Teacher Development Expense: Teacher development expenses such as travel, tuition, etc. associated with development training.
Administrative Expense: Sum of Administrative Expenses (salaries, facilities, materials) allocated proportionally to each course.

As an example at the class level, the total class level expense is the total of the classroom teaching expense, the classroom supply expense, the laboratory teaching expense, the laboratory supply expense and the development expense. Therefore, the class level teaching effectiveness according to the present invention is the net classroom instructional improvement divided by the total class level expense.

The following are examples of effort measurements at a grade level reflecting, for example, all classes in one particular grade across a school such as all sophomores in a given high school:
Grade Classroom Teaching Expense: Sum of the Classroom Teaching Expense by grade or course.
Grade Classroom Supply Expense: Sum of Classroom Supply Expense by grade or course.
Grade Laboratory Teaching Expense: Sum of Laboratory Teaching Expense by grade or course.
Grade Laboratory Supply Expense: Sum of Laboratory Supply Expense by grade or course.
Grade Development Expense: Sum of Teacher Development Expense by grade or course.
Grade Administrative Expense: Sum of Administrative Expenses (salaries, facilities, materials) allocated proportionally to each grade.

As an example at the grade level, the total grade level expense (effort) is the total of the grade classroom teaching expense, the grade classroom supply expense, the grade laboratory teaching expense, the grade laboratory supply expense and the grade development expense. Therefore, the grade level teaching effectiveness according to the present invention is the total classroom instructional improvement for the grade divided by the total grade level expense.

The following are examples of effort measurements at a school level reflecting, for example, all classes in all grades across a given school such as all grades/classes in a given high school:
School Classroom Teaching Expense: Sum of Classroom Teaching Expense by individual school
School Classroom Supply Expense: Sum of Classroom Supply Expense by individual school
School Laboratory Teaching Expense: Sum of Laboratory Teaching Expense by individual school
School Laboratory Supply Expense: Sum of Laboratory Supply Expense by individual school

As an example at the school level, the total school level expense (effort) is the total of the school classroom teaching expense, the school classroom supply expense, the school laboratory teaching expense, the school laboratory supply expense, the school administrative expense and the school development expense. Therefore, the school level teaching effectiveness according to the present invention is the total school instructional improvement for the entire school divided by the total school level expense.

The following are examples of effort measurements at a school system reflecting, for example, all schools in a geographic area such as all public schools in New York City:
School System Classroom Teaching Expense: Sum of Classroom Teaching Expense over School System
School System Classroom Supply Expense: Sum of Classroom Supply Expense over School System
School System Laboratory Teaching Expense: Sum of Laboratory Teaching Expense over School System
School System Laboratory Supply Expense: Sum of Laboratory Supply Expense over School System

As an example at the school system level, the total school system level expense (effort) is the total of the school system teaching expense, the school system supply expense, the school system teaching expense, the school system laboratory supply expense, the school system administrative expense and the school system development expense. Therefore, the school system teaching effectiveness according to the present invention is the total school system instructional improvement for the entire school system divided by the total school system level expense.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for measuring an efficiency and effectiveness of educational activities, the system comprising:
a computer including at least a processor, memory and storage;
software running on the computer for accepting inputs indicating an amount of effort expended and accumulating the inputs indicating the amount of effort expended into an accumulated effort;
software running on the computer for accepting inputs indicating an amount of costs expended and accumulating the inputs indicating the amount of cost expended into an accumulated cost;
software running on the computer for accepting inputs indicating a knowledge level of a group of students before the educational activities are performed;
software running on the computer for accepting inputs indicating a knowledge level of the group of students after the educational activities;
software running on the computer for calculating the efficiency and effectiveness of the educational activities by calculating a difference between the knowledge level of the group of students before the educational activities and the knowledge level of the group of students after the teaching activities divided by the accumulated effort; and
software running on the computer for calculating the efficiency and effectiveness of the educational activities by calculating a difference between the knowledge level of the group of students before the educational activities and the knowledge level of the group of students after the teaching activities divided by the accumulated cost.

2. The system for measuring an efficiency and effectiveness of educational activities of claim 1, wherein the amount of effort includes time spent on at least one activity selected from the group consisting of student and teacher classroom time, student time spent on homework, student time spent on other study activities, time spent by an educator on ancillary activities, time spent grading tests, time spent grading homework, time spent reviewing the curriculum, time spent modifying the curriculum, time spent reviewing the class plan, and time spent modifying the class plan.

3. The system for measuring an efficiency and effectiveness of educational activities of claim 1, wherein the amount of effort is measured in hours.

4. The system for measuring an efficiency and effectiveness of educational activities of claim 1, wherein the amount of effort is measured in hours and the amount of cost is measured by one or more costs selected from the group consisting of wages, salaries, benefits, administrative expenses, operations expenses, maintenance expenses, and other education related expenses.

5. The system for measuring an efficiency and effectiveness of educational activities of claim 2, wherein the efficiency and effectiveness of the educational activities represents one efficiency selected from the group consisting of an individual course efficiency, an individual course effectiveness, a grade-level efficiency, a grade-level efficiency, a school-level efficiency, a school-level effectiveness, a regional-school-level efficiency and a regional-school-level effectiveness.

6. The system for measuring an efficiency and effectiveness of educational activities of claim 2, wherein the wherein the amount of effort further includes overhead allocated between the teaching activities and at least one other teaching activity.

7. A method for measuring educational efficiency and effectiveness of an educator with a group of students, the method comprising:
measuring amounts of effort expended related to educational activities with the group of students;
accumulating the amounts of effort expended during the educational activities into an accumulated effort;
measuring the knowledge level of the group of students before the educational activities;
measuring the knowledge level of the group of students after the educational activities; and
calculating the educational efficiency and effectiveness based upon the difference between the knowledge level of the group of students before the educational activities and the knowledge level of the group of students after the educational activities divided by the accumulated effort.

8. The method for measuring educational efficiency and effectiveness of an educator with a group of students of claim 7, wherein the amounts of effort includes time spent on at least one activity selected from the group consisting of student and teacher classroom time, student time spent on homework, student time spent on other study activities, time spent by an educator on ancillary activities, time spent grading tests, time spent grading homework, time spent reviewing the curriculum, time spent modifying the curriculum, time spent reviewing the class plan, and time spent modifying the class plan.

9. The method for measuring educational efficiency and effectiveness of an educator with a group of students of claim 7, wherein the amounts of effort is measured in hours.

10. The method for measuring educational efficiency and effectiveness of an educator with a group of students of claim 7, further comprising the steps of:
tracking amounts of expense expended related to the educational activities;
accumulating the amounts of expenses related to the educational activities into an accumulated expense; and
calculating the educational efficiency and effectiveness based upon the difference between the knowledge level of the group of students before the educational activities and the knowledge level of the group of students after the educational activities divided by the accumulated expense.

11. The method for measuring educational efficiency and effectiveness of an educator with a group of students of claim 8, wherein the educational efficiency and effectiveness represents one efficiency selected from the group consisting of an individual course efficiency, a grade-level efficiency, a school-level efficiency and a regional-school-level efficiency.

12. The method for measuring educational efficiency and effectiveness of an educator with a group of students of claim 8, wherein the wherein the amounts of effort further includes overhead allocated between the teaching activities and at least one other teaching activities.

13. The method for measuring educational efficiency and effectiveness of an educator with a group of students of claim 10, wherein the amounts of expenses related to the educational activities includes at least one expense selected from the group consisting of the classroom supply expenses, the laboratory teaching expenses, the laboratory supply expenses, the administrative expenses and the development expenses.

14. The method for measuring educational efficiency and effectiveness of an educator with a group of students of claim 10, wherein the amounts of expenses related to the educational activities includes at least one expense selected from the group consisting of educator direct wages, aide's direct wages, educator direct benefits, aide's direct benefits, laboratory teacher direct wages, laboratory teacher aide's direct wages, laboratory teacher direct benefits, laboratory teacher aide's direct benefits, administrator direct wages and administrator direct benefits.

15. A computer readable medium tangibly embodying a program of instructions, the program of instructions configured to for measuring educational efficiency and effectiveness of an educator with a group of students, the program of instructions comprising:
computer instructions for measuring amounts of effort expended related to educational activities with the group of students;
computer instructions for accumulating the amounts of effort expended related to the educational activities with the group of students into an accumulated effort;
computer instructions for measuring the knowledge level of the group of students before the educational activities;
computer instructions for measuring the knowledge level of the group of students after the educational activities; and
computer instructions for calculating the educational efficiency and effectiveness of the educator with the group of students based upon a difference between the knowledge level of the group of students before the educational activities and the knowledge level of the group of students after the educational activities divided by the accumulated effort.

16. The computer readable medium tangibly embodying a program of instructions, the program of instructions configured to for measuring educational efficiency and effectiveness of an educator with a group of students of claim 15, wherein the amounts of effort includes time spent on at least one activity selected from the group consisting of student and teacher classroom time, student time spent on homework, student time spent on other study activities, time spent by an educator on ancillary activities, time spent grading tests, time spent grading homework, time spent reviewing the curriculum, time spent modifying the curriculum, time spent reviewing the class plan, and time spent modifying the class plan.

17. The computer readable medium tangibly embodying a program of instructions, the program of instructions configured to for measuring educational efficiency and effectiveness of an educator with a group of students of claim 13, wherein the amounts of effort is measured in hours.

18. The computer readable medium tangibly embodying a program of instructions, the program of instructions configured to for measuring educational efficiency and effectiveness of an educator with a group of students of claim 15, further comprising the steps of:
computer instructions for tracking amounts of expense expended related to the educational activities;
computer instructions for accumulating the amounts of expenses related to the educational activities into an accumulated expense; and
computer instructions for calculating the educational efficiency and effectiveness based upon the difference between the knowledge level of the group of students before the educational activities and the knowledge level of the group of students after the educational activities divided by the accumulated expense.

19. The computer readable medium tangibly embodying a program of instructions, the program of instructions configured to for measuring educational efficiency and effectiveness of an educator with a group of students of claim 16, wherein the teaching efficiency represents one efficiency selected from the group consisting of an individual course efficiency, a grade-level efficiency, a school-level efficiency and a regional-school-level efficiency.

20. The computer readable medium tangibly embodying a program of instructions, the program of instructions configured to for measuring educational efficiency and effectiveness of an educator with a group of students of claim 18, wherein the amounts of expenses related to the educational activities includes at least one expense selected from the group consisting of educator direct wages, aide's direct wages, educator direct benefits, aide's direct benefits, laboratory teacher direct wages, laboratory teacher aide's direct wages, laboratory teacher direct benefits, laboratory teacher aide's direct benefits, administrator direct wages and administrator direct benefits.
